(19) United States
(12) Patent Application Publication
(10) Pub. No.: US 2011/0158417 A1
(43) Pub. Date: Jun. 30, 2011

(54) COMMUNICATION DEVICE WITH WARNING FUNCTION AND COMMUNICATION METHOD THEREOF

(75) Inventor: KAI-YU LIN, Taoyuan (TW)

(73) Assignee: FOXCONN COMMUNICATION TECHNOLOGY CORP., Taoyuan County (TW)

(21) Appl. No.: 12/939,185

(22) Filed: Nov. 4, 2010

(30) Foreign Application Priority Data
Dec. 28, 2009 (CN) 200910312405.8

(51) Int. Cl. G08B 21/00; H04R 29/00

(52) U.S. Cl. 381/56; 340/540

(57) ABSTRACT

A communication device with an audio database comprises an audio receiving module, a locator module, an audio identification module and a notification module. The audio receiving module calculates the strength of the at least one signal, the locator module determines whether each of the strength exceeds a predefined value and determines the directionality of the at least one audio signal in accordance with the strength of the at least one audio signal. The audio identification module compares the audio signal with audio modules in accordance with characteristics parameter to issue a warning.

### BACKGROUND

1. Technical Field

The present disclosure relates to a communication device, and more particularly to a communication device providing warnings by detecting and recognizing audio signals.

2. Description of Related Art

A modern urban environment can be especially hazardous for the sensorally impaired. For instance, the hearing impaired may have limited or no capability to react to sounds indicating dangers, such verbal warnings from others, automobile horns, or speeding vehicles. Obviously, the increase in risk for those described is considerable.

Accordingly, electronic devices specifically designed for such situations have been developed. However, such devices are often only capable of indicating the originating direction of origin of such sounds, with no specific identification thereof.

### BRIEF DESCRIPTION OF THE DRAWINGS

FIG. 1 is a schematic structural diagram of one embodiment of a communication device as disclosed.

FIG. 2 is a functional diagram of an audio warning module of the communication device of FIG. 1.

FIG. 3 is a flowchart of one embodiment of a method for warning issue in the communication device as disclosed.

FIG. 4 is a compliance rule list of the communication device of FIG. 1.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

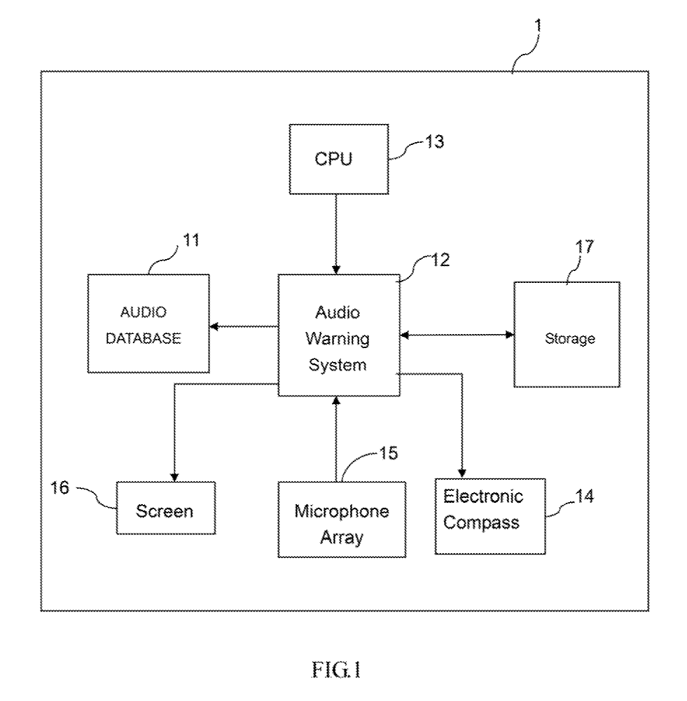

FIG. 1 is a schematic structural diagram of one embodiment of communication device 1 as disclosed. A warning system 12 of the communication device 1 includes an audio database 11, a central processing unit (CPU) 13, an electronic compass 14, a microphone array 15, a screen 16 and a storage 17. In one exemplary embodiment, the audio database 11 stores different audio modules and characteristics of audio identification. Each of the audio modules includes data for specific characteristics of audio identification, such as human voice audio module or vehicle noise module, which can be accessed to identify category of audio signals received by the microphone array 15.

The CPU 13 initiates and controls the warning system 12. The warning system 12 detects information received by the microphone array 15 and issues at least one warning when notable situations occur. In one exemplary embodiment, the electronic compass determines whether the movement direction of the communication device 1 is consistent with the directionality of an audio source. The movement direction of the communication device 1 can be defined as the directionality of an audio signal received by the microphone array 15 if the moving direction of the communication device 1 is consistent with the directionality of an audio source. The microphone array 15 determines the directionality of the audio signal. If the movement direction of the communication device 1 is not consistent with the directionality of the audio signal, the electronic compass 14 determines the directionality of the audio source so as to reduce error in the determination process. The storage 17 stores information detected by the warning system 12, and the warning system 12 is capable of accessing information from the storage 17. In one embodiment, information can be the directionality of the audio signal received by the microphone array 15.

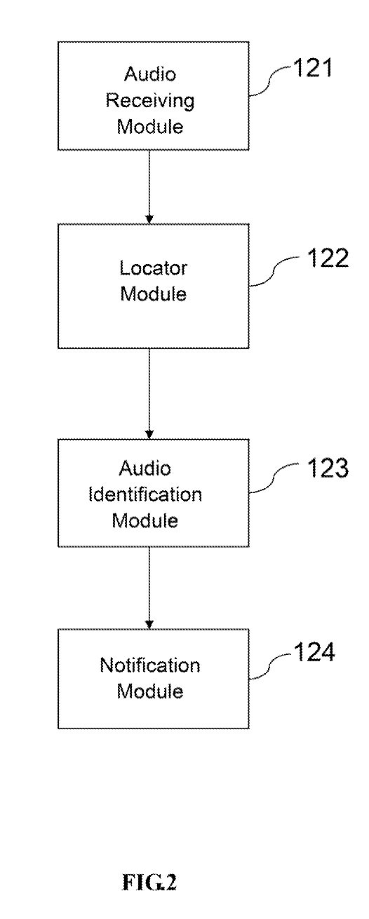

FIG. 2 is a functional diagram of the warning system 12 of the communication device of FIG. 1. The warning system 12 includes an audio receiving module 121, a locator module 122, an audio identification module 123 and a notification module 124. The modules 121-124 may comprise computerized code in the form of one or more programs that are stored in the storage 17 (or memory). The computerized code includes instructions that are executed by the CPU 13 to provide functions for modules 121-124.

The audio receiving module 121 analyzes the audio signals received by the microphone array 15. In an exemplary embodiment, the audio receiving module 121 calculates strength of each audio signal (e.g., measuring how many decibels of the audio signal) respectively when audio signals from more than two directions are received at the same time. Moreover, the audio receiving module 121 calculates the strength of each audio signal respectively as well when more than one audio signal from the same direction is received by the microphone array 15 at the same time.

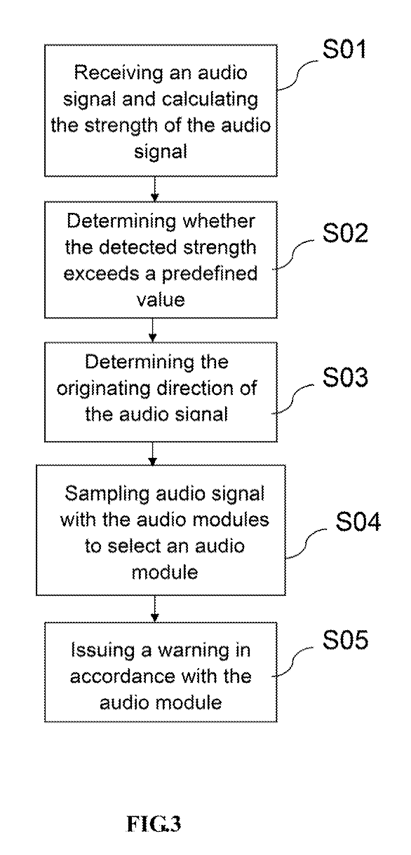

The locator module 122 determines whether strengths of the received signals exceed a predefined value, and also the directionality of the signal in accordance with the strength thereof. In an exemplary embodiment, the strength of the audio signal can be defined as the amplitude of the audio signal. It should be noted that the detection process of the locator module 122 is disclosed as follows, referring to FIG. 3.

The audio identification module 123 compares the audio signal with the audio modules stored in the audio database 11 in accordance with the characteristics stored in the audio database 11. In one exemplary embodiment, the audio identification module 123 accesses the characteristics from the audio database 11 then for comparison with the audio signal received by the microphone array 15 in accordance with the characteristics. The audio identification module 123 then compares the sampled audio signals with the audio modules stored in the audio database 11 to select an audio module corresponding to the sampled audio signal. The notification module 124 issues a warning in accordance with the selected audio module to provide the originating direction of the audio source. In one exemplary embodiment, a vibration is issued first, and then a corresponding warning is displayed on the screen 16. The warnings can be icons representing people or vehicles accompanying the originating direction of the audio signal. In the other exemplary embodiment, icons can be a man-shape icon, a vehicle-shape icon, a direction icon, or a vibration hint, the vibration is followed by specific audio messages identifying the type and the directionality of the threat. If earphones are in use, the audio messages can be played back via the communication channel between the communication device 1 and the earphone.

In another exemplary embodiment, the notification module 124 sends multiple sets of warnings in accordance with the type of each audio source identified by the audio identification module 123, when the microphone array 15 detects two or more audio sources at the same time. It should be noted that the definition of the microphone array 15 shall not be limited to a physical structure with multiple microphones, but should be referred to functionality that the microphone array 15 is capable of detecting audio sources from different directions at the same time.

FIG. 3 is a flowchart of one embodiment of a method for warning issue in a communication device as disclosed. Depending on the embodiment, additional blocks in the flow of FIG. 3 may be added, others removed, and the ordering of the blocks may be changed.

In Block S01, the locator module 122 receives an audio signal received by the microphone array 15 and calculates the strength of the audio signal.

In Block S02, the locator module 122 determines whether the detected strength exceeds a predefined value.

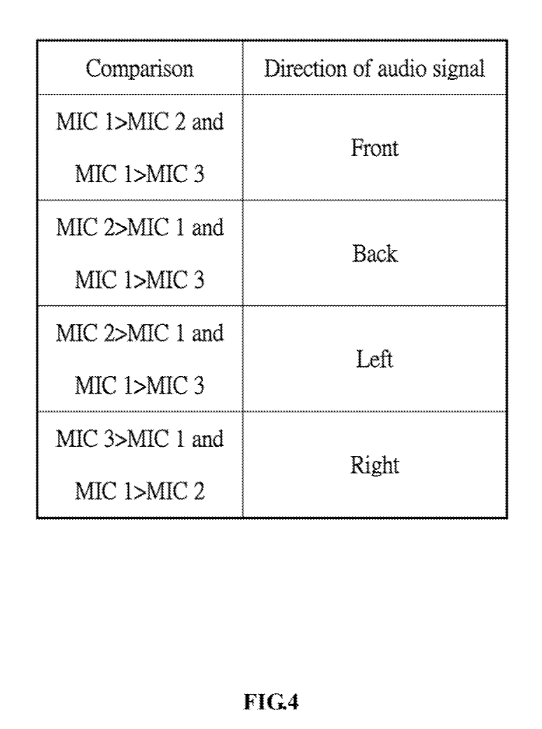

In Block S03, the locator module 122 determines the directionality of the audio signal in accordance with the strength thereof. In one exemplary embodiment, the locator module 122 receives multiple audio signals from the microphone array 15 then compares the strengths of the audio signals with a compliance rule list predefined and stored in the communication device 1. FIG. 4 is one embodiment of the compliance rule list as disclosed. The microphone array 15 has three microphones, MIC 1, MIC 2 and MIC 3. When strength of the audio signal received by MIC 1 exceeds those received by MIC 2, the locator module 122 determines the originating direction of the audio source is ahead. As disclosed, the compliance rile list can determine which direction the originating direction of the audio source is from all detected directions of the microphone array 15.

In Block S04, the audio identification module 123 then compares the sampled audio signal with the audio modules stored in the audio database 11 to select an audio module corresponding to the sampled audio signal.

In Block S05, the notification module 124 issues a warning in accordance with the audio module to provide the originating direction of the audio source.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A communication device with an audio database, comprising:
a microphone array that detect at least one audio signal;
an audio receiving module that receives the at least one audio signal and calculating strength of the at least one signal;
a locator module that determines whether the strength exceeds a predefined value and determines a directionality of the at least one audio signal in accordance with the strength of the at least one audio signal;
an audio identification module that compares the audio signal with audio modules in accordance with characteristics parameter, wherein the audio modules and the characteristics parameter are stored in the audio database; and
a notification module that issues a warning in accordance with the selected audio module.

2. The communication device of claim 1, wherein the locator module samples the audio signal to select one of the audio modules corresponding to the sampled audio signal.

3. The communication device of claim 1, wherein the warning can be selected from a group at least consisting of a man-shape icon, a vehicle-shape icon, a direction icon, and a vibration hint.

4. The communication device of claim 2, wherein the warning can be selected from the group consisting of audio module stored in the audio database and the directionality of the audio signal.

5. The communication device of claim 2, wherein the microphone array is capable of detecting a plurality of audio sources from different directions at the same time.

6. The communication device of claim 1, wherein the communication device determining the directionality of the audio sources by comparing the strength of the audio source with each other.

7. A communication method for warning issue comprising:
receiving an audio signal detected and calculating the strength of the audio signal;
determining whether the detected strength exceeds a predefined value;
determining a directionality of the audio signal in accordance with the strength of audio signal; and
sending a warning in accordance with the audio module to provide the originating direction of the audio source.

8. The method of claim 7 further comprising samplizng the audio signal in accordance with characteristic parameters and comparing the sampled audio signal with the audio modules to select an audio module corresponding to the sampled audio signal, wherein the characteristic parameters and the audio modules are stored in the audio database.

9. The method of claim 8 further comprising receiving multiple audio signals from the microphone array then comparing the strengths in accordance with a compliance rule list predefined and stored in the communication device

10. The method of claim 7, wherein the warning can be selected from the group consisting of audio module stored in the audio database and the directionality of the audio signal.

11. The method of claim 7, wherein the warning is a human shape, a vehicle shape icon, a direction icon, or a vibration hint.

12. The method of claim 11, wherein the microphone array is capable of detecting a plurality of audio sources from different directions at the same time.
